(19) United States
(12) Patent Application Publication
(10) Pub. No.: US 2016/0290974 A1
(43) Pub. Date: Oct. 6, 2016

(54) DETERMINATION OF PIPE WALL FAILURE BASED ON MINIMUM PIPE WALL THICKNESS

(71) Applicant: Mueller International, LLC, Atlanta, GA (US)

(72) Inventors: Matthew Simon Coleman, Rozelle NSW (AU); Bryan C. Thompson, Toronto (CA)

(21) Appl. No.: 14/674,851

(22) Filed: Mar. 31, 2015

(51) Int. Cl. G01N 29/44; G01N 29/04

(52) U.S. Cl. CPC G01N 29/449; G01N 29/04; G01N 2291/0289; G01N 2291/02854; G01N 2291/0234

(57) ABSTRACT

Examples of calculating a minimum pipe wall to determine a pipe wall failure probability are disclosed. In one example implementation according to aspects of the present disclosure, a first acoustical sensor is connected to a pipe a distance from a second acoustical sensor connected to the pipe. A computing system is communicatively coupleable to the first and second acoustical sensors. The computing system calculates an average maximum pit depth value of a plurality of pits in an outer surface of a pipe wall of the pipe from a known initial pipe wall thickness value and an average present pipe wall thickness value. The computing system also calculates a minimum present pipe wall thickness by applying a statistical technique to the calculated average maximum pit depth value. The computing system determines a pipe wall failure probability based at least in part on the minimum present pipe wall thickness value.

### BACKGROUND

A utility provider may install and maintain infrastructure to provide utility services to its customers. For example, a water utility provider may install piping infrastructure to distribute water to its customers. Over time, the exterior of the piping infrastructure may corrode or otherwise degrade. The corrosion or degradation may occur as a result of chemicals or other corrosive substances in the soil around the pipes of the piping infrastructure. The corrosion or degradation may manifest as “pitting” in the external surface of the pipes of the piping infrastructure. The pitting weakens the pipes over time and may become significant enough to cause a failure of the pipe.

### BRIEF DESCRIPTION OF THE DRAWINGS

The following detailed description references the drawings, in which:

FIG. 1 illustrates a diagram of an environment to collect pipe wall thickness data of a pipe wall for a section of pipe according to examples of the present disclosure;

FIG. 2 illustrates a block diagram of a computing system to apply a Gumbel distribution to determine a pipe failure probability according to examples of the present disclosure;

FIG. 3 illustrates a computer-readable storage medium storing instructions to determine pipe wall failure probability using statistical techniques according to examples of the present disclosure;

FIG. 4 illustrates a flow diagram of a method to determine a pipe wall failure based on a minimum pipe wall thickness according to examples of the present disclosure;

FIG. 5 illustrates a flow diagram of a method to determine a pipe wall failure based on a minimum pipe wall thickness according to examples of the present disclosure;

FIG. 6 illustrates a table of results of collected pipe wall thickness data of a pipe wall for several sections of pipes; and

FIG. 7 illustrates a chart of an estimated pipeline performance according to examples of the present disclosure.

### DETAILED DESCRIPTION

Water utility providers may utilize risk-based asset management approaches to aging infrastructure to determine risks of failure. Briefly, this involves multiplying the probability of a failure of a water pipe used to deliver water by the water utility provider to its customers by the consequences of a failure to determine the risk (e.g., cost) of the asset. Accurate failure prediction is useful in calculating the risk of the asset. One example of failure prediction is through determining average pipe wall thickness measurements. This provides an indication of how a pipe is aging and how corrosion is affecting the pipe. From this, a failure prediction can be determined.

In some situations average pipe wall thickness may be determined using a pressure wave velocity applied using a speed wave equation and solving for the thickness. This provides average pipe wall thickness, which may be compared to the original pipe wall thickness to analyze the condition of the pipe and to determine a failure prediction for the pipe. However, metallic pipelines may degrade and corrode in a non-uniform fashion, both internally and externally. One of the established limitations of the current failure prediction techniques in metallic pipelines is the extreme variation in pipe wall thickness over the test length due to the non-uniform degradation and corrosion. Failures typically occur at a location of a minimum pipe wall thickness, not at a location of the average pipe wall thickness.

Tests of segments of exhumed cast iron pipes have been performed to determine pipe wall thickness by plotting the external pitting patterns using, for example, a laser scanner. By applying one of a variety of statistical techniques to the test data, the pipe wall thickness may be determined at nearly any point along the test segments. In examples, the following statistical techniques may be applied: a continuous probability distribution such as a Gumbel distribution, a Weibull distribution, or a Gaussian (e.g. normal) distribution, a generalized extreme value distribution such as a Fréchet distribution, and other suitable distributions and statistical techniques.

Various implementations are described below by referring to several examples of calculating a minimum pipe wall to determine a pipe wall failure probability are disclosed. In one example implementation according to aspects of the present disclosure, a first acoustical sensor is connected to a pipe a distance from a second acoustical sensor connected to the pipe. A computing system is communicatively coupleable to the first and second acoustical sensors. The computing system calculates an average maximum pit depth value of a plurality of pits in an outer surface of a pipe wall of the pipe from a known initial pipe wall thickness value and an average present pipe wall thickness value. The computing system also calculates a minimum present pipe wall thickness by applying a statistical technique to the calculated average maximum pit depth value. The computing system determines a pipe wall failure probability based at least in part on the minimum present pipe wall thickness value. Other examples are described in the present disclosure.

The present disclosure enables more accurate failure prediction of pipes in a piping infrastructure. In some implementations, using the average pipe wall thickness to determine a minimum wall thickness accounts for the significant variation in thickness of metallic pipelines, the variation in thickness being due to non-uniform corrosion. These and other advantages will be apparent from the description that follows.

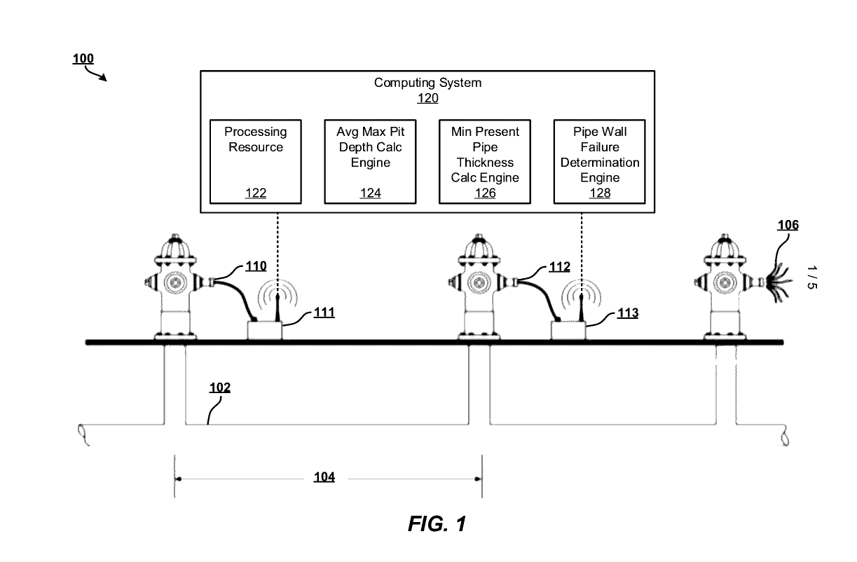

FIGS. 1-3 include particular components, modules, instructions, engines, etc. according to various examples as described herein. In different implementations, more, fewer, and/or other components, modules, instructions, engines, arrangements of components/modules/instructions/engines, etc. may be used according to the teachings described herein. In addition, various components, modules, engines, etc. described herein may be implemented as instructions stored on a computer-readable storage medium, hardware modules, special-purpose hardware (e.g., application specific hardware, application specific integrated circuits (ASICs), embedded controllers, hardwired circuitry, etc.), or some combination or combinations of these.

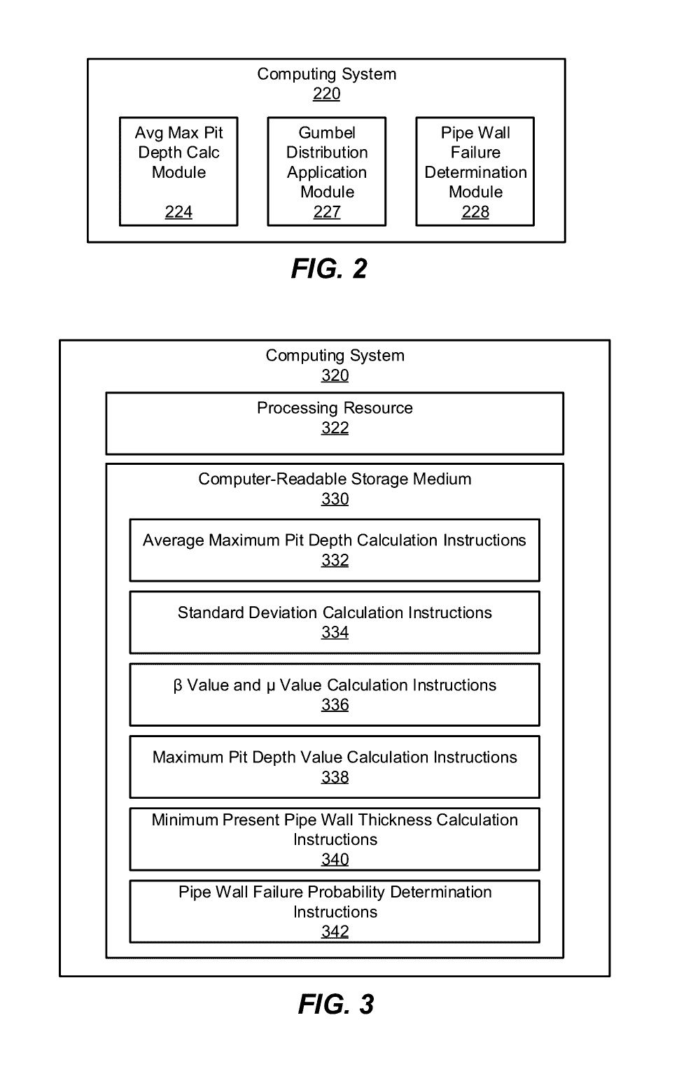

Generally, FIGS. 1-3 relate to components and modules of a computing system, such as computing system 120 of FIG. 1, computing system 220 of FIG. 2, and computing system 320 of FIG. 3. It should be understood that the computing systems 120, 220, and 320 may include any appropriate type of computing system and/or computing device, including for example smartphones, tablets, desktops, laptops, workstations, servers, smart monitors, smart televisions, digital signage, scientific instruments, retail point of sale devices, video walls, imaging devices, peripherals, networking equipment, wearable computing devices, or the like.

FIG. 1 illustrates a diagram of an environment 100 to collect pipe wall thickness data of a pipe wall for a section of pipe according to examples of the present disclosure. In examples, the pipe wall thickness data may be collected by causing a pressure wave within the pipe 102, for example, by flowing or impact. The acoustical sensors 110 and 112 detect acoustical signals caused by the pressure wave within the pipe 102 to which the acoustical sensors 110 and 112 are directly or indirectly connected. For example, the acoustical sensors 110 and 112 may be directly connected to the pipe 102. In other examples, the acoustical sensors 110 and 112 may be indirectly connected to the pipe 102 via other elements (e.g., hydrants, valves, couplers, corporation stops, etc.) of a fluid distribution system containing the pipe 102. The acoustical sensors 110 and 112 transmit signals, such as through a wired and/or wireless network, to computing system 120, which then calculates an average maximum pit depth value and a minimum present wall thickness value. The computing system 120 then determines a pipe wall failure probability from the calculated minimum present pipe wall thickness value. These aspects of the present disclosure are described in additional detail herein.

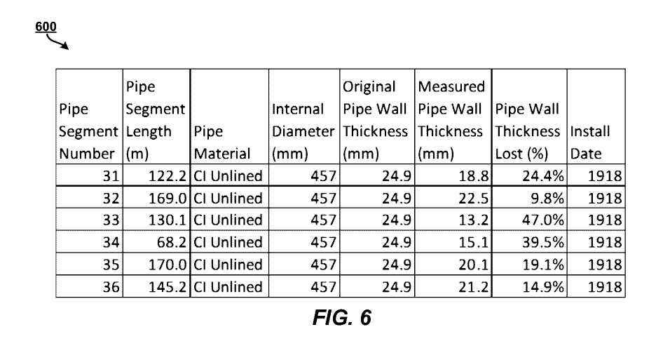

The acoustical sensors 110 and 112 may detect acoustical signals caused by the pressure wave within the pipe 102. The pressure wave within the pipe 102 may be caused, for example, by flow 106, which causes a water flow within the pipe 102 across distance 104. For example, the acoustical sensors 110 and 112 may determine a time of flight between the two acoustical sensors 110 and 112. Using the time of flight information, structural wall thickness of the pipe wall is determined. The structural wall thickness accounts for “pitting” in the external surface of the pipe wall due to corrosion and/or degradation of the external surface of the pipe wall that occurs over time. The determined pipe wall thickness represents the average thickness over the test length, which may be approximately 100 meters in examples, although the test length may be shorter or longer in other examples. Examples of collected pipe wall thickness data that represents pit depth of the pits in the external surface of the pipe are illustrated in FIG. 6.

The acoustical sensors 110 and 112 may transmit the pit depth data to the computing system 120 via a wired or wireless network. In examples, such as shown in FIG. 1, the acoustical sensors 110 and 112 may be communicatively coupleable to transceivers 111 and 113 respectively. The transceivers 111 and 113 communicate data, such as pit depth data, from the acoustical sensors 110 and 112 to the computing system 120, which may include an interface (not shown) for receiving the data from the acoustical sensors 110 and 112 via the transceivers 111 and 113 respectively. The transceivers 111 and 113 may be any suitable device for sending, receiving, or sending and receiving data, such as a receiver, a transmitter, a transmitter-receiver, and/or a transceiver. It should be appreciated that any suitable communication technique may be implemented to transmit the data between the acoustical sensors 110 and 112 and the computing system 120.

The dotted lines of FIG. 1 illustrate communicative paths between the computing system 120 and the transceivers 111 and 113. These paths generally represent a network that may include hardware components and computers interconnected by communications channels that allow sharing of resources and information. The network may include one or more of a cable, wireless, fiber optic, or remote connection via a telecommunication link, an infrared link, a radio frequency link, or any other connectors or systems that provide electronic communication. The network may include, at least in part, an intranet, the internet, or a combination of both. The network may also include intermediate proxies, routers, switches, load balancers, and the like. The paths followed by the network between the computing system 120 and the transceivers 111 and 113 as depicted in FIG. 1 represent the logical communication paths between these devices, not necessarily the physical paths between the devices.

The computing system 120 may include a processing resource 122 that represents generally any suitable type or form of processing unit or units capable of processing data or interpreting and executing instructions. The processing resource 122 may be one or more central processing units (CPUs), microprocessors, and/or other hardware devices suitable for retrieval and execution of instructions. The instructions may be stored, for example, on a memory resource (not shown), such as computer-readable storage medium 330 of FIG. 3, which may include any electronic, magnetic, optical, or other physical storage device that store executable instructions. Thus, the memory resource may be, for example, random access memory (RAM), electrically-erasable programmable read-only memory (EPPROM), a storage drive, an optical disk, and any other suitable type of volatile or non-volatile memory that stores instructions to cause a programmable processor (i.e., processing resource) to perform the techniques described herein. In examples, the memory resource includes a main memory, such as a RAM in which the instructions may be stored during runtime, and a secondary memory, such as a nonvolatile memory in which a copy of the instructions is stored.

Additionally, the computing system 120 may include an average maximum pit depth value calculation engine 124, a minimum present pipe wall thickness calculation engine 126, and a pipe wall failure probability determination engine 128. In examples, the engines described herein may be a combination of hardware and programming. The programming may be processor executable instructions stored on a tangible memory, and the hardware may include processing resource 122 for executing those instructions. Thus a memory resource (not shown) can be said to store program instructions that when executed by the processing resource 122 implement the engines described herein. Other engines may also be utilized as will be discussed further below in other examples.

Alternatively or additionally, the computing system 120 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processing resources (or processing resources utilizing multiple processing cores) may be used, as appropriate, along with multiple memory resources and/or types of memory resources.

The average maximum pit depth value calculation engine 124 calculates an average maximum pit depth value of a plurality of pits in an outer surface of a pipe wall of the pipe 102 from a known initial pipe wall thickness value and a present pipe wall thickness value. The average present pipe wall thickness value is determined using the pit depth data collected by the first acoustical sensor and the second acoustical sensor and relates to the depths of the plurality of pits in the outer surface of the pipe wall of the pipe 102.

In examples, to calculate the average present pipe wall thickness value, the average maximum pit depth value calculation engine 124 applies the a wave speed equation as follows, solving for average present pipe wall thickness of the pipe:

$$v = {v}_{o} \sqrt{\frac{1}{1 + \frac{{D}_{i}}{{t}_{r}} + \frac{{K}_{w}}{{E}_{p}}}}$$

where v is the measured velocity, vₒ is the propagation velocity in an infinite body of water, Dᵢ is the pipe's internal diameter, K_{w} is the bulk modulus of the water (i.e., liquid) flowing within the pipe, Eₚ is the elastic modulus of the pipe wall, and tᵣ is the average present pipe wall thickness of the pipe. The average present pipe wall thickness of the pipe represents the average present pipe wall thickness of the pipe 102 over distance 104. The average present pipe wall thickness is then used to calculate the average maximum pit depth value by subtracting the present pipe wall thickness value from a known initial pipe wall thickness value (i.e., the thickness of the pipe wall at the time it was initially installed). In the case of pitting on a pipe, the average maximum pit depth value (or “mean”) refers to the average pit depth per slice along the pipe 102.

Once the average maximum pit depth value has been calculated, the minimum present pipe wall thickness calculation engine 126 calculates a minimum present pipe wall thickness by applying a statistical technique to the calculated average maximum pit depth value. The statistical technique may be any suitable statistical technique such as Gumbel distribution, a Weibull distribution, a Gaussian distribution, a Fréchet distribution, and the like.

Applying the statistical technique, in the case of a Gumbel distribution for example, may include calculating a mean, calculating a standard deviation, calculating a β value, calculating a μ value, applying a cumulative distribution function or a probability distribution function to calculate a maximum pit depth value, and subtracting the maximum pit depth value from the average pipe wall thickness to determine the minimum pipe wall thickness. Calculating the mean (i.e., the average present pipe wall thickness) is performed by the average maximum pit depth value calculation engine 124 as discussed above. A standard deviation is then calculated based on the average present pipe wall thickness. In particular the minimum present pipe wall thickness calculation engine 126 calculates a standard deviation value of the pit depth data for the plurality of pits in the outer surface of the pipe from the calculated average maximum pit depth value. The minimum present pipe wall thickness calculation engine 126 calculates a β value and a μ value using the average maximum pit depth value and the standard deviation value.

The minimum present pipe wall thickness calculation engine 126 then calculates a maximum pit depth value by applying a cumulative distribution function or a probability distribution function using the β value, the μ value, and the test distance 104, which represents the distance between the acoustical sensor 110 and the acoustical sensor 112. Maximum pit depth can be predicted by evaluating the cumulative distribution function or the probability distribution function at the value of slice width per total pipe length. In examples, the cumulative distribution function of the Gumbel distribution may be expressed as follows:

$${e}^{- e \frac{- ( x - μ )}{β}} .$$

The cumulative distribution function is equal to the test length (i.e., distance 104 of FIG. 1) divided by the individual pipe segment lengths of the test length (for example, 3.3 meters, although other lengths may be possible). By solving the cumulative distribution function for x, the maximum pit depth value is determined. By extension, the results can be extrapolated to longer lengths of pipe assuming that the corrosion conditions are similar. Finally, the minimum present pipe wall thickness calculation engine 126 calculates the minimum present pipe wall thickness by subtracting the maximum pit depth value from the known initial pipe wall thickness value.

After the minimum present pipe wall thickness is calculated, the pipe wall failure probability determination engine 128 determines a pipe wall failure probability. The failure probability is based on the minimum present pipe wall thickness value since many pipe wall failures occur at a location with a minimum pipe wall thickness. The failure probability may also provide an indication of the pipe's remaining life.

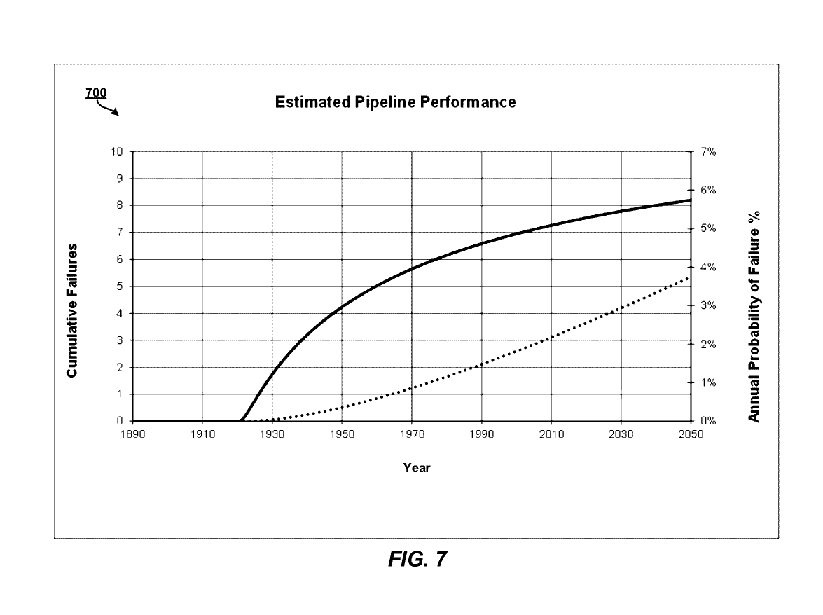

In some examples, the computing system 120 may include a display. The display may be or include a monitor, a touchscreen, a projection device, and/or a touch/sensory display device. The display may display text, images, and other appropriate graphical content. In examples, the display may display estimated pipeline performance, such as illustrated in FIG. 7, as determined by the pipe wall failure probability determination engine 128. The computing system 120 may also include a network interface to communicatively couple the computing system 120 to the transceivers 111 and 113 via the network and to other computing systems and/or computing devices.

FIG. 2 illustrates a block diagram of a computing system 220 to apply a Gumbel distribution to determine a pipe failure probability according to examples of the present disclosure. The computing system 220 may include an average maximum pit depth value calculation module 224, a Gumbel distribution application module 227, and a pipe wall failure probability determination module 228. In examples, the modules described herein may be a combination of hardware and programming instructions. The programming instructions may be processor executable instructions stored on a tangible memory resource such as a computer-readable storage medium or other memory resource, and the hardware may include a processing resource for executing those instructions. Thus the memory resource can be said to store program instructions that when executed by the processing resource implement the modules described herein.

Other modules may also be utilized as will be discussed further below in other examples. In different implementations, more, fewer, and/or other components, modules, instructions, and arrangements thereof may be used according to the teachings described herein. In addition, various components, modules, etc. described herein may be implemented as computer-executable instructions, hardware modules, special-purpose hardware (e.g., application specific hardware, application specific integrated circuits (ASICs), and the like), or some combination or combinations of these.

The average maximum pit depth value calculation module 224 calculates an average maximum pit depth value of a plurality of pits in an outer surface of a pipe wall of the pipe (such as pipe 102 of FIG. 1) from a known initial pipe wall thickness value and a present pipe wall thickness value. The average present pipe wall thickness value is determined using the pit depth data collected by the first acoustical sensor and the second acoustical sensor and relates to the depths of the plurality of pits in the outer surface of the pipe wall of the pipe.

In examples, to calculate the average present pipe wall thickness value, the average maximum pit depth value calculation module 224 applies the wave speed equation as discussed herein, solving for average present pipe wall thickness of the pipe. The average present pipe wall thickness is then used to calculate the average maximum pit depth value by subtracting the present pipe wall thickness value from a known initial pipe wall thickness value (i.e., the thickness of the pipe wall at the time it was initially installed). In the case of pitting on a pipe, the average maximum pit depth value (or “mean”) refers to the average pit depth per slice along the pipe.

Once the average maximum pit depth value has been calculated, the Gumbel distribution application module 227 applies a Gumbel distribution to the calculated average maximum pit depth value. In other examples, other statistical techniques may be applied instead of the Gumbel distribution, such as a Weibull distribution, a Gaussian distribution, a Fréchet distribution, and the like.

Applying the Gumbel distribution may include calculating a mean, calculating a standard deviation, calculating a β value, calculating a μ value, applying a cumulative distribution function to calculate a maximum pit depth value, and subtracting the maximum pit depth value from the average pipe wall thickness to determine the minimum pipe wall thickness. Calculating the mean (i.e., the average present pipe wall thickness) is performed by the average maximum pit depth value calculation module 224 as discussed above. A standard deviation is then calculated based on the average present pipe wall thickness. In particular the Gumbel distribution application module 227 calculates a standard deviation value of the pit depth data for the plurality of pits in the outer surface of the pipe from the calculated average maximum pit depth value. The Gumbel distribution application module 227 calculates a β value and a μ value using the average maximum pit depth value and the standard deviation value.

The Gumbel distribution application module 227 then calculates a maximum pit depth value by applying a cumulative distribution function using the β value, the μ value and the test distance, which represents the distance between the ends of the test segment of pipe. Maximum pit depth can be predicted by evaluating the cumulative distribution function at the value of slice width per total pipe length. In examples, the cumulative distribution function of the Gumbel distribution may be expressed as follows:

$${e}^{- e \frac{- ( x - μ )}{β}} .$$

The cumulative distribution function is equal to the test length (i.e., distance 104 of FIG. 1) divided by the individual pipe segment lengths of the test length (for example, 3.3 meters, although other lengths may be possible). By solving the cumulative distribution function for x, the maximum pit depth value is determined. By extension, the results can be extrapolated to longer lengths of pipe assuming that the corrosion conditions are similar. Finally, the Gumbel distribution application module 227 calculates the minimum present pipe wall thickness by subtracting the maximum pit depth value from the known initial pipe wall thickness value.

After the minimum present pipe wall thickness is calculated, the pipe wall failure probability determination module 228 determines a pipe wall failure probability. The failure probability is based on the minimum present pipe wall thickness value since many pipe wall failures occur at a location with a minimum pipe wall thickness. The failure probability may also provide an indication of the pipe's remaining life.

In examples, the pipe wall failure probability determination module 228 determines a wall thickness lost percentage between the minimum pipe wall thickness value and the known initial pipe wall thickness value. As described in detail herein regarding FIG. 6, the pipe wall failure probability is determined to be low, for example, when the wall thickness lost percentage is less than about 10%, the pipe wall failure probability is determined to be moderate, for example, when the wall thickness lost percentage is between about 10% and about 30%, and the pipe wall failure probability is determined to be high, for example, when the wall thickness lost percentage is greater than about 30%. In other examples, other percentages may differentiate between low, moderate, and high failure probabilities, and other or additional classifications may be utilized, such as extremely low and/or extremely high. In some examples, determining the pipe wall failure probability may utilize the following attributes relating to the pipe: installation date of the pipe (i.e., age of the pipe), diameter of the pipe, material of the pipe, depth of the pipe in the ground, surge pressure of the test surge, test date, and internal lining date.

FIG. 3 illustrates a computer-readable storage medium 330 storing instructions 332-342 to determine pipe wall failure probability using statistical techniques according to examples of the present disclosure. The computer-readable storage medium 330 is non-transitory in the sense that it does not encompass a transitory signal but instead is made up of one or more memory components configured to store the instructions 332-342. The computer-readable storage medium 330 may be representative of a memory resource and may store machine executable instructions 332-342, which are executable on a computing system such as computing system 120 of FIG. 1 and/or computing system 220 of FIG. 2 as well as the computing system 320 of FIG. 3 in conjunction with processing resource 322.

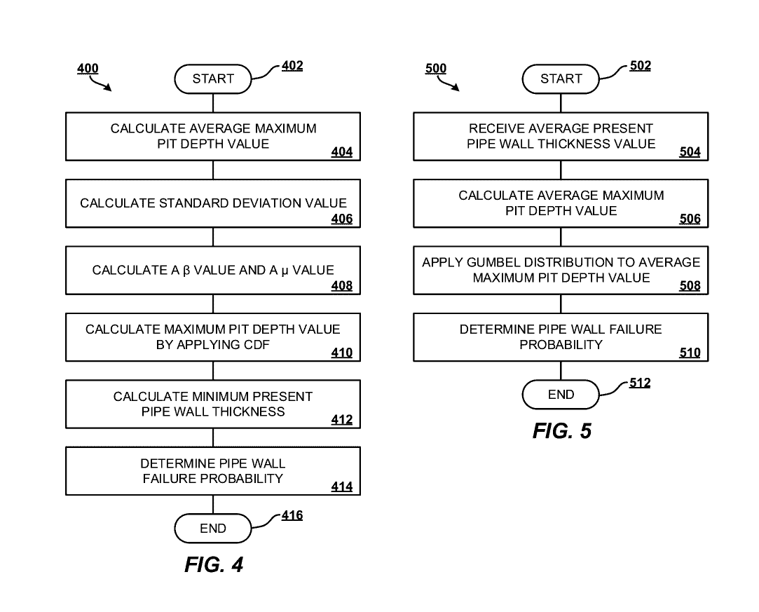

In the example shown in FIG. 3, the instructions 332-342 may include average maximum pit depth calculation instructions 332, standard deviation calculation instructions 334, β value and μ value calculation instructions 336, maximum pit depth calculation instructions 338, minimum present pipe wall thickness calculation instructions 340, and pipe wall failure probability determination instructions 342. The instructions 332-342 of the computer-readable storage medium 330 may be executable so as to perform the techniques described herein, including the functionality described regarding the method 400 of FIG. 4.

For example, the average maximum pit depth calculation instructions 332 may correspond to block 404 of FIG. 4. The standard deviation calculation instructions 334 may correspond to block 406 of FIG. 4. The β value and μ value calculation instructions 336 may correspond to block 408 of FIG. 4. The maximum pit depth calculation instructions 338 may correspond to block 410 of FIG. 4. The minimum present pipe wall thickness calculation instructions 340 may correspond to block 412 of FIG. 4. The pipe wall failure probability determination instructions 342 may correspond to block 414 of FIG. 4.The functionality of these instructions is described below with reference to the functional blocks of FIG. 4 but should not be construed as so limiting.

In particular, FIG. 4 illustrates a flow diagram of a method 400 to determine a pipe wall failure based on a minimum pipe wall thickness according to examples of the present disclosure. The method 400 may be executed by a computing system or a computing device such as computing system 120 of FIG. 1, computing system 220 of FIG. 2, and/or computing system 320 of FIG. 3. The method 400 may also be stored as instructions on a non-transitory computer-readable storage medium such as computer-readable storage medium 330 of FIG. 3 that, when executed by a processing resource (e.g., processing resource 122 of FIG. 1 and/or processing resource 322 of FIG. 3), cause the processing resource to perform the method 400.

At block 402, the method 400 begins and continues to block 404. At block 404, the method 400 includes calculating an average maximum pit depth value. For example, a computing system (e.g., computing system 120 of FIG. 1, computing system 220 of FIG. 2, and/or computing system 320 of FIG. 3) calculates an average maximum pit depth value of a plurality of pits in an outer surface of a pipe wall of a pipe from a known initial pipe wall thickness value and an average present pipe wall thickness value. In examples, the average present pipe wall thickness value is determined using pit depth data collected by a first acoustical sensor connected to the pipe wall and a second acoustical sensor connected to the pipe wall. The pit depth data relates to the depths of the plurality of pits in the outer surface of the pipe wall. The method 400 continues to block 406.

At block 406, the method 400 includes calculating a standard deviation value. For example, the computing system calculates a standard deviation value of the pit data for the plurality of pits in the outer surface of the pipe from the average maximum pit depth value. The method 400 continues to block 408.

At block 408, the method 400 includes calculating a β value and a μ value. For example, the computing system calculates a β value and a μ value using the average maximum pit depth value and the standard deviation value. The method 400 continues to block 410.

At block 410, the method 400 includes calculating a maximum pit depth value by apply a cumulative distribution function (CDF). For example, the computing system calculates a maximum pit depth value by applying a cumulative distribution function using the β value, the μ value, and the distance. The cumulative distribution function may be expressed as:

$${e}^{- e \frac{- ( x - μ )}{β}} .$$

The method 400 continues to block 412.

At block 412, the method 400 includes calculating a minimum present pipe wall thickness. For example, the computing system calculates a minimum present pipe wall thickness by subtracting the maximum pit depth value from the known initial pipe wall thickness value. The method 400 continues to block 414.

At block 414, the method 400 includes determining a pipe wall failure probability. For example, the computing system determines a pipe wall failure probability based at least in part on the minimum present pipe wall thickness value. In examples, determining the pipe wall failure probability may include determining a wall thickness lost percentage between the minimum pipe wall thickness value and the known initial pipe wall thickness value. The method 400 continues to block 416 and terminates.

Additional processes also may be included, and it should be understood that the processes depicted in FIG. 4 represent illustrations, and that other processes may be added or existing processes may be removed, modified, or rearranged without departing from the scope and spirit of the present disclosure.

FIG. 5 illustrates a flow diagram of a method 500 to determine a pipe wall failure based on a minimum pipe wall thickness according to examples of the present disclosure. The method 500 may be executed by a computing system or a computing device such as computing system 120 of FIG. 1, computing system 220 of FIG. 2, and/or computing system 320 of FIG. 3. The method 500 may also be stored as instructions on a non-transitory computer-readable storage medium such as computer-readable storage medium 330 of FIG. 3 that, when executed by a processing resource (e.g., processing resource 122 of FIG. 1 and/or processing resource 322 of FIG. 3), cause the processing resource to perform the method 500.

At block 502, the method 500 begins and continues to block 504. At block 504, the method 500 includes receiving an average present pipe wall thickness value. For example, a computing system (e.g., computing system 120 of FIG. 1, computing system 220 of FIG. 2, and/or computing system 320 of FIG. 3) receives an average present pipe wall thickness value of a pipe wall of a pipe determined using a first acoustical sensor connected to the pipe a distance from a second acoustical sensor connected to the pipe. In examples, the first and second acoustical sensors sense a pressure wave in a substance, such as water, within the pipe. The method 500 continues to block 506.

At block 506, the method 500 includes calculating an average maximum pit depth value. For example, the computing system calculates an average maximum pit depth value by subtracting the received average present pipe wall thickness value from a known initial pipe wall thickness value. The method 500 continues to block 508.

At block 508, the method 500 includes applying a Gumbel distribution to the average maximum pit depth value to determine a minimum present pipe wall thickness value. Although a Gumbel distribution is applied, applying other statistical techniques may be appropriate instead, including at least a Weibull distribution, a Gaussian distribution, and a Fréchet distribution. In examples, applying the Gumbel distribution may include the computing system calculating a standard deviation value of the pit depth data for the plurality of pits in the outer surface of the pipe from the average maximum pit depth value. In examples, applying the Gumbel distribution may further include the computing system calculating a β value and a μ value using the average maximum pit depth value and the standard deviation value. In examples, applying the Gumbel distribution may further include the computing system calculating a maximum pit depth value by applying a cumulative distribution function or a probability distribution function using the β value, the μ value, and the distance. In examples, applying the Gumbel distribution may further include the computing system calculating the minimum present pipe wall thickness by subtracting the maximum pit depth value from the known initial pipe wall thickness value. The method 500 continues to block 510.

At block 510, the method 500 includes determining a pipe wall failure probability. For example, the computing system determines a pipe wall failure probability based at least in part on the minimum present pipe wall thickness value. The pipe wall failure probability determination may include, in examples, determining a wall thickness lost percentage between the minimum pipe wall thickness value and the known initial pipe wall thickness value. In examples, a pipe wall failure probability is determined to be low when the wall thickness lost percentage is less than about 10%, moderate when between about 10% and about 30%, and high when greater than about 30%. The method 500 continues to block 512 and terminates.

Additional processes also may be included, and it should be understood that the processes depicted in FIG. 5 represent illustrations, and that other processes may be added or existing processes may be removed, modified, or rearranged without departing from the scope and spirit of the present disclosure.

FIG. 6 illustrates a table of results 600 of collected pipe wall thickness data of a pipe wall for several sections of pipes. In particular, the table includes results of collected pipe wall thickness data for sections 31-36 of a pipe. Although the pipe wall thickness data may be interpreted in many ways, one example of interpreting the pipe wall thickness data is as follows:

A wall thickness lost percentage less than 10% may indicate that the pipe segment is in good condition. In this example, the segment may have minor levels of degradation and/or isolated areas with minor thickness loss of structural thickness. Minor levels of uniform corrosion or some localized areas with pitting corrosion may exist. Examples of a pipe segment in good condition is segment number 32 of FIG. 6. Segments in good condition may have a low probability of failure.

A wall thickness lost percentage between 10% and 30% may indicate that the pipe segment is in moderate condition. In this example, the segment may have considerable levels of degradation and loss of structural thickness. Considerable levels of uniform surface or internal corrosion and/or localized areas of pitting corrosion may exist on metallic pipes. Examples of pipe segments in fair condition are segment numbers 31, 35, and 36 of FIG. 6. Segments in moderate condition may have a moderate probability of failure.

A wall thickness lost percentage greater than 30% may indicate that the pipe segment is in poor condition. In this example, the segment may have significant degradation and loss of structural thickness. Significant uniform corrosion and/or numerous areas of localized pitting corrosion may exist on metallic pipes. Examples of pipe segments in poor condition are segment numbers 33 and 34 of FIG. 6. Segments in poor condition may have a high probability of failure.

FIG. 7 illustrates a chart 700 of an estimated pipeline performance according to examples of the present disclosure. In the example chart 700, two lines are graphed: a solid line representing the pipe wall failure probability of a test pipe, and the dotted line representing cumulative failures. In the present example, the first estimated failure of the test pipe is 2018. No failures have occurred to date. The minimum pipe wall thickness is estimated to be 3.86 millimeters. The probability of failure this year is estimated to be 1.6%. The number of failures per 100 miles per year is estimated to be 8.

To test the techniques of the present disclosure, data from different existing sources was examined. The data came from various exhumed pipe samples where pit depth measurements were taken by pit depth gauge, by magnetic flux leakage equipment, and/or by laser scanning tools. Maximum pit depth predictions on approximately 50 exhumed sample pipe segments were determined using the present techniques, and the maximum pit depth was over predicted on average by 22% with the maximum pit depths generally being on the order of 10.5 mm or less.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A system, comprising:
a first acoustical sensor connected to a pipe a distance from a second acoustical sensor connected to the pipe; and
a computing system communicatively coupleable to the first acoustical sensor and the second acoustical sensor, the computing system comprising:
an average maximum pit depth value calculation module to calculate an average maximum pit depth value of a plurality of pits in an outer surface of a pipe wall of the pipe from a known initial pipe wall thickness value and an average present pipe wall thickness value, the average present pipe wall thickness value being determined using pit depth data collected by the first acoustical sensor and the second acoustical sensor, the pit depth data relating to the depths of the plurality of pits in the outer surface of the pipe wall,
a minimum present pipe wall thickness calculation module to calculate a minimum present pipe wall thickness by applying a statistical technique to the calculated average maximum pit depth value, and
a pipe wall failure probability determination module to determine a pipe wall failure probability based at least in part on the minimum present pipe wall thickness value.

2. The system of claim 1, wherein applying the statistical technique further comprises:
calculating a standard deviation value of the pit depth data for the plurality of pits in the outer surface of the pipe from the average maximum pit depth value.

3. The system of claim 2, wherein applying the statistical technique further comprises:
calculating a β value and a μ value using the average maximum pit depth value and the standard deviation value.

4. The system of claim 3, wherein applying the statistical technique further comprises:
calculating a maximum pit depth value by applying a cumulative distribution function using the β value, the μ value, and the distance.

5. The system of claim 4, wherein applying the statistical technique further comprises:
calculating the minimum present pipe wall thickness by subtracting the maximum pit depth value from the known initial pipe wall thickness value.

6. The system of claim 1, wherein the statistical technique is selected from the group consisting of a Gumbel distribution, a Weibull distribution, a Gaussian distribution, and a Fréchet distribution.

7. The system of claim 1, wherein calculating an average maximum pit depth value comprises:
applying the following equation
$$v = {v}_{o} \sqrt{\frac{1}{1 + \frac{{D}_{i}}{{t}_{r}} + \frac{{K}_{w}}{{E}_{p}}}} ;$$
and
solving for the average present pipe wall thickness value.

8. The system of claim 1, wherein the pipe wall failure probability determination further comprises determining a wall thickness lost percentage between the minimum pipe wall thickness value and the known initial pipe wall thickness value.

9. The system of claim 8, wherein the pipe wall failure probability is determined to be low when the wall thickness lost percentage is less than about 10%.

10. The system of claim 8, wherein the pipe wall failure probability is determined to be moderate when the wall thickness lost percentage is between about 10% and about 30%.

11. The system of claim 8, wherein the pipe wall failure probability is determined to be high when the wall thickness lost percentage is greater than about 30%.

12. A method, comprising:
receiving an average present pipe wall thickness value of a pipe wall of a pipe determined using a first acoustical sensor connected to the pipe a distance from a second acoustical sensor connected to the pipe, the first and second acoustical sensors sensing a pressure wave in a substance within the pipe;
calculating an average maximum pit depth value by subtracting the received average present pipe wall thickness value from a known initial pipe wall thickness value;
applying a Gumbel distribution to the average maximum pit depth value to determine a minimum present pipe wall thickness value; and
determining a pipe wall failure probability based at least in part on the minimum present pipe wall thickness value.

13. The method of claim 12, wherein applying the Gumbel distribution further comprise:
calculating a standard deviation value of the pit depth data for the plurality of pits in the outer surface of the pipe from the average maximum pit depth value.

14. The method of claim 13, wherein applying the Gumbel distribution further comprise:
calculating a β value and a μ value using the average maximum pit depth value and the standard deviation value.

15. The method of claim 14, wherein applying the Gumbel distribution further comprise:
calculating a maximum pit depth value by applying a cumulative distribution function using the β value, the μ value, and the distance.

16. The method of claim 15, wherein applying the Gumbel distribution further comprise:
calculating the minimum present pipe wall thickness by subtracting the maximum pit depth value from the known initial pipe wall thickness value.

17. The method of claim 12,
wherein the pipe wall failure probability determination further comprises determining a wall thickness lost percentage between the minimum pipe wall thickness value and the known initial pipe wall thickness value,
wherein the pipe wall failure probability is determined to be low when the wall thickness lost percentage is less than about 10%,
wherein the pipe wall failure probability is determined to be moderate when the wall thickness lost percentage is between about 10% and about 30%, and
wherein the pipe wall failure probability is determined to be high when the wall thickness lost percentage is greater than about 30%.

18. A non-transitory computer-readable storage medium storing instructions that, when executed by a processing resource, cause the processing resource to:
calculate an average maximum pit depth value of a plurality of pits in an outer surface of a pipe wall of a pipe from a known initial pipe wall thickness value and an average present pipe wall thickness value, the average present pipe wall thickness value being determined using pit depth data collected by a first acoustical sensor connected to the pipe wall and a second acoustical sensor connected to the pipe wall, the pit depth data relating to the depths of the plurality of pits in the outer surface of the pipe wall;
calculate a standard deviation value of the pit data for the plurality of pits in the outer surface of the pipe from the average maximum pit depth value;
calculate a β value and a μ value using the average maximum pit depth value and the standard deviation value;
calculate a maximum pit depth value by applying a cumulative distribution function using the β value, the μ value, and the distance;
calculate a minimum present pipe wall thickness by subtracting the maximum pit depth value from the known initial pipe wall thickness value; and
determining a pipe wall failure probability based at least in part on the minimum present pipe wall thickness value.

19. The non-transitory computer-readable storage medium of claim 18, wherein the cumulative distribution function is expressed as:
$${e}^{- e \frac{- ( x - μ )}{β}} .$$

20. The non-transitory computer-readable storage medium of claim 18,
wherein the pipe wall failure probability determination further comprises determining a wall thickness lost percentage between the minimum pipe wall thickness value and the known initial pipe wall thickness value.
